(19) United States
(12) Patent Application Publication
(10) Pub. No.: US 2011/0167604 A1
(43) Pub. Date: Jul. 14, 2011

(54) Fixture for aligning and installing drawer fronts/faces to drawer boxes

(76) Inventors: Thomas D. Stewart, Sedona, AZ (US); Bert F. Peabody, Locust Grove, GA (US)

(21) Appl. No.: 12/657,051

(22) Filed: Jan. 12, 2010

(51) Int. Cl. B25B 11/02; B25B 27/14

(52) U.S. Cl. 29/271; 269/41

(57) ABSTRACT

A portable fixture/method for installing drawer fronts/faces to drawer boxes. The fixture provides the proper alignment/orientation of the drawer front/face to the drawer box based on two dimensions set by the user. Said dimensions, covers full inset to full overlay application and is easily set by the user. The drawer box is then screwed to the drawer front/face and the assembly is installed in the cabinet box.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This device generally relates to the field of woodworking, specifically to aligning and installing a drawer front/face to a drawer box.

2. Prior Art

Attaching and aligning drawer fronts/faces is a time consuming and tedious process in the cabinetry industry. One solution can be found in U.S. Pat. No. 5,018,711 to D. L. Johnson (1991) that discloses a complex clamp, which temporarily secures the drawer front to the drawer box with the drawer closed. The drawer front can then be aligned and secured. This clamping device is both complex and cumbersome to use and does not necessarily provide a significant reduction in installation time. In addition, potential damage to the drawer front exists, as well as fine adjustments will most likely be required after the clamp is removed.

Another solution can be found in U.S. Pat. No. 6,695,420 to T. E. Ackerman (2004) which discloses a semi complex system of attaching a fixture to the drawer box, attaching hook & loop material to the drawer front, which will attach to the fixture with the drawer closed. The drawer is then secured in position. Once the fixture is removed, fine adjustment of the drawer front will most likely be required in addition to removing the hook & loop material.

Still another solution has been to use drawer front adjuster screw assemblies. These devices require the worker to drill two 20 mm holes about ½ inch deep into the back of the drawer front. The worker then pounds a plastic plug into the hole in the drawer front. The plastic plug has a center void with a nut. The worker drills two holes in the drawer box and attaches a screw through the hole and into the nut. The location of the holes must be relatively precise as the adjusters are only for fine adjustment. A number of problems may occur using this solution that could result in lost time and materials: Time required to locate holes; damaged drawer front if drilled to deep; broken plastic plug that must be removed.

Thus, there exists a need for an easier and faster way to install a drawer front/face to a drawer box with only minor, if any, fine adjustment.

### SUMMARY

In accordance with one embodiment, a portable fixture is used to locate the drawer front/face relative to the desired position of the drawer box. The drawer box is then placed on the drawer front/face and attached using screws. A hole in the drawer box is made slightly larger than the screw to allow for fine adjustment, if needed. The drawer assembly is then installed in the main component/cabinet and adjusted, if needed. Typically, just minor horizontal adjustment may be needed.

### DRAWINGS

### Figures

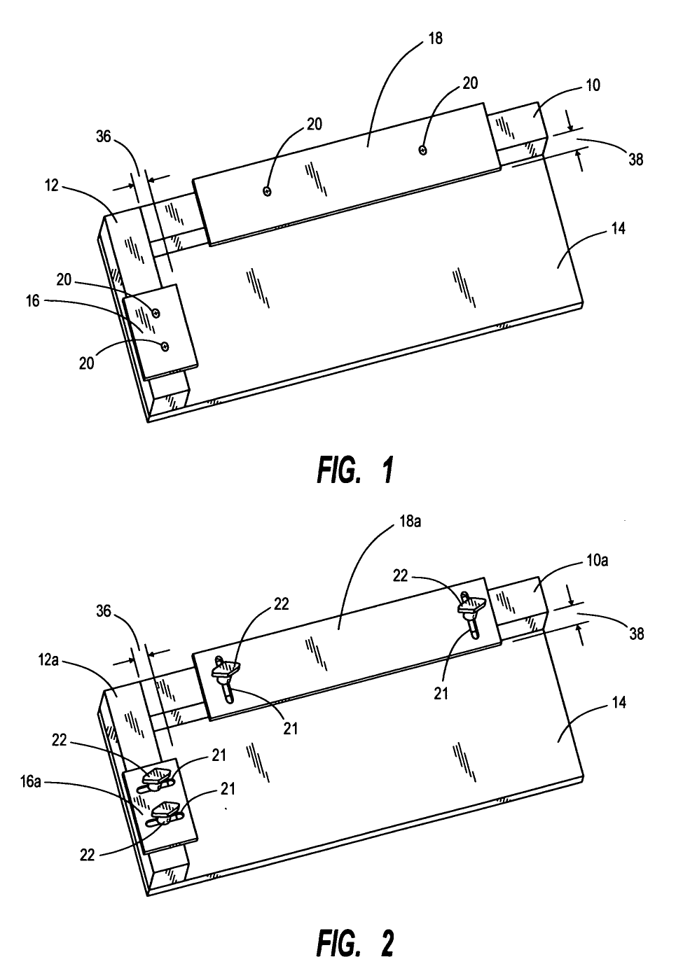

FIG. 1 shows a fixture with fixed side and bottom supports set to a specific side and bottom support setting in accordance with one embodiment.

FIG. 2 shows a similar fixture with adjustable side and bottom supports so that the support settings are variable in accordance with another embodiment.

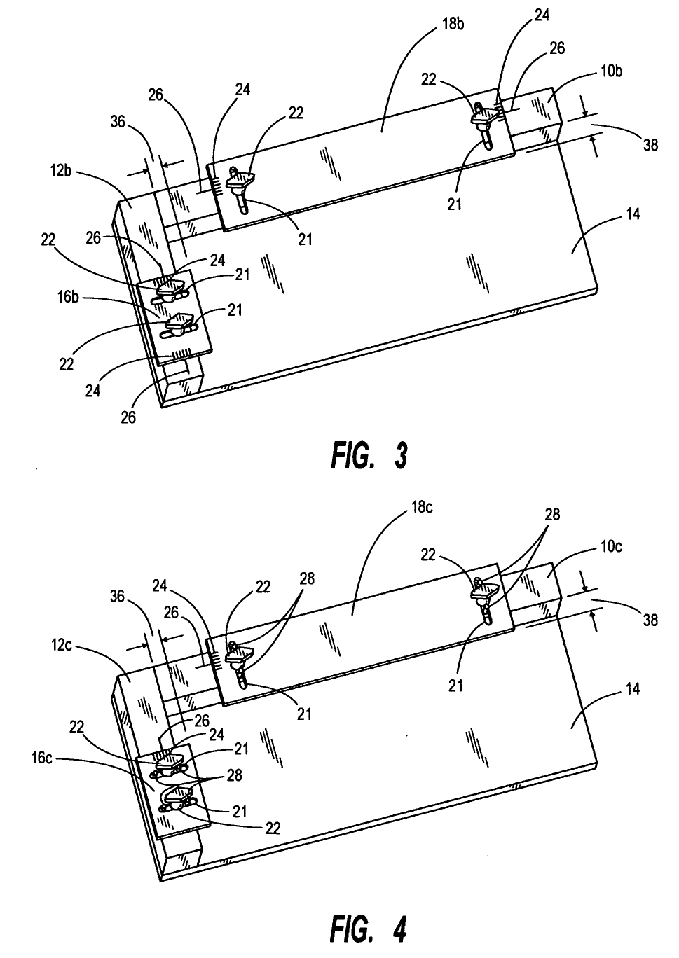

FIG. 3 shows a similar fixture with adjustable side and bottom supports with graduations and an index mark or pointer to simplify setting the supports in accordance with another embodiment.

FIG. 4 shows a similar fixture with adjustable side and bottom supports having pins in the slots that ensure the supports stay horizontal with the members when changing the settings. Graduations and an index mark or pointer is only required on one end of the supports. This is in accordance with another embodiment.

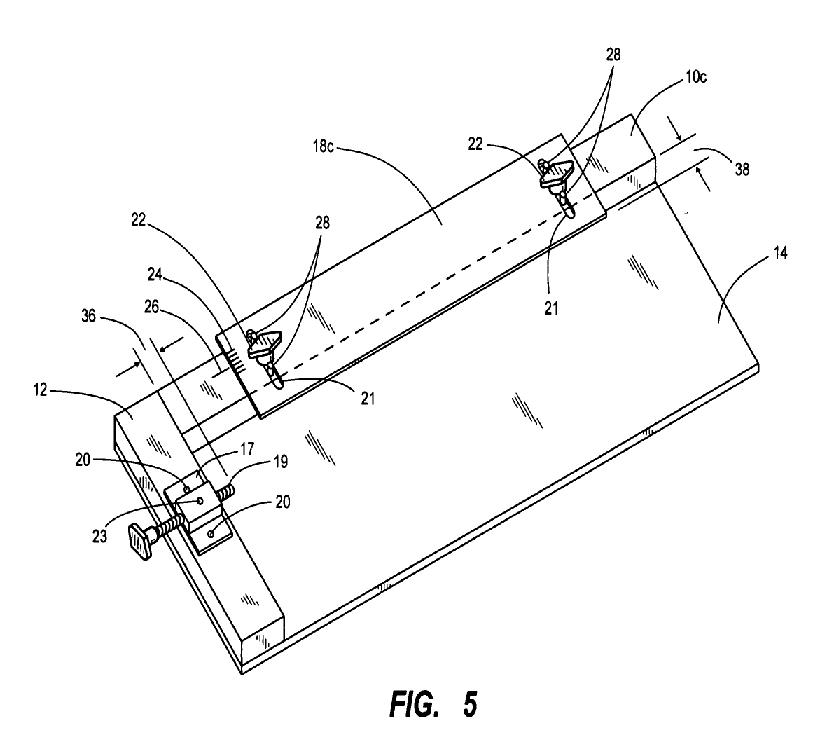

FIG. 5 shows a similar fixture with the side support removed. In its place is an adjustment screw/stop. This is in accordance with another embodiment.

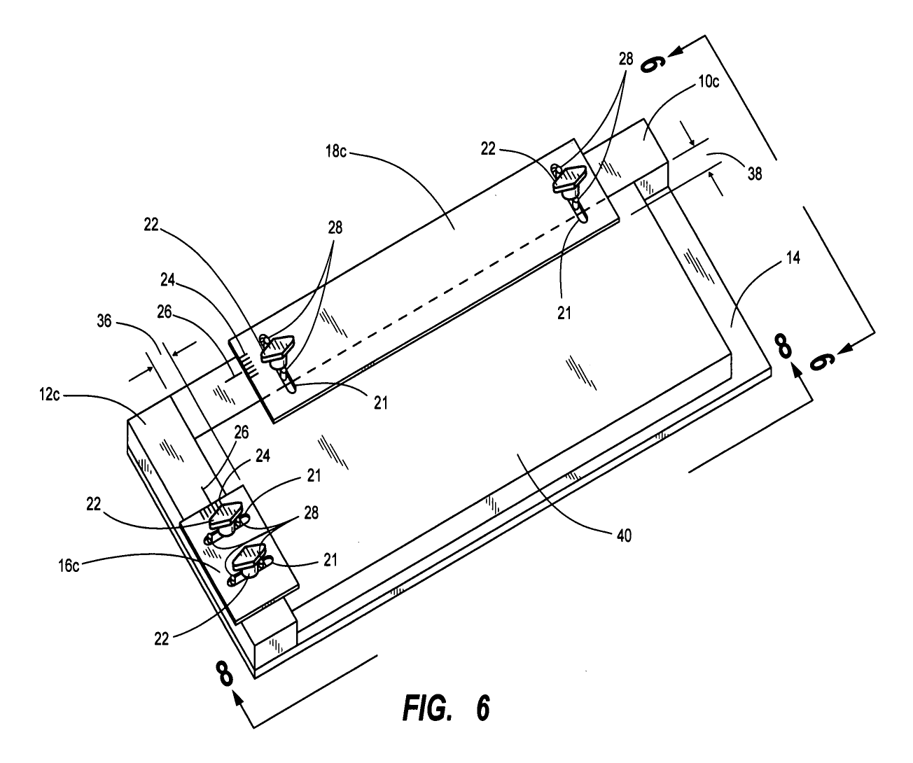

FIG. 6 shows the preferred embodiment of the fixture with a drawer front/face placed in the fixture.

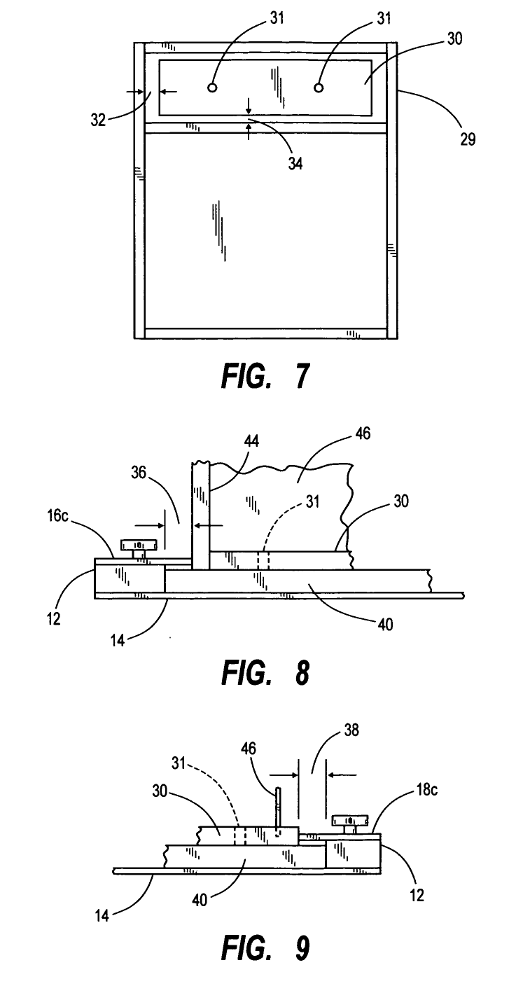

FIG. 7 shows a typical cabinet box with a drawer box installed, less drawer front/face.

FIG. 8 shows a side view of the fixture with a drawer front/face and drawer box installed in the fixture.

FIG. 9 shows an end view of the fixture with a drawer front/face and drawer box installed in the fixture. For illustration purposes, the right-hand side of the drawer box is not shown.

### DRAWINGS

### Reference Numerals

10 bottom fixture member
10a bottom fixture member with threads for locking knob 22
10b bottom fixture member with threads for locking knob 22, index marks 26
10c bottom fixture member with threads for locking knob 22, index marks 26, and alignment pins 28
12 side fixture member
12a side fixture member with threads for locking knob 22
12b side fixture member with threads for locking knob 22, index marks 26
12c side fixture member with threads for locking knob 22, index marks 26, and alignment pins 28
14 fixture base
16 side support
16a side support with the addition of slots 21
16b side support with the addition of slots 21 and graduations 24
16c side support with the addition of slots 21, and graduations 24, and pins 28
17 screw adjustment saddle or block
18 bottom support
18a bottom support with the addition of slots 21
18b bottom support with the addition of slots 21 and graduations 24
18c bottom support with the addition of slots 21, and graduations 24, and pins 28
19 adjustment screw/stop
20 screws
21 slots
22 screw knobs
23 locking set screw 24
24 graduations, English and/or metric
26 index mark
28 alignment pins
29 typical cabinet box with drawer box installed
30 drawer box front member
31 holes in drawer box
32 drawer slide set back (DSSB)
34 bottom clearance (BC)
36 side support setting (SSS)
38 bottom support setting (BSS)
40 drawer front/face
44 drawer box L/H side
46 drawer box bottom

### DETAILED DESCRIPTION

Most any material may be used in the construction of this fixture, such as wood, plastic, metal, etc.

FIG. 1 shows the first embodiment, which is the bases of the fixture. The fixture is assembled by first attaching bottom fixture member 10 to side fixture member 12 perpendicular to each other. This assembly is then attached to fixture base 14. The thickness of fixture member's 10 and 12 should be slightly thicker then the drawer front/faces so as to allow the drawer front/face to slide under supports 16 and 18. The side support 16 is set to dimension SSS 36 and attached with screws 20 to side fixture member 12. The bottom support 18 is set to dimension BSS 38 and attached with screws 20 to bottom fixture member 10.

FIG. 2 shows the second embodiment, which consists of adding slots 21 to the side support 16a and the bottom support 18a. Screw threads, such as brass or metal inserts, are added to bottom and side fixture members 10a and 12a to accept screw knobs 22. This enhances the use of the fixture when changing settings SSS 36 and BSS 38 with more ease.

FIG. 3 shows the third embodiment, which consists of adding graduations 24 in English and/or Metric to side support 16b and bottom support 18b. Index marks 26 are added to bottom member 10b and side member 12b calibrated to the graduations 24. This further enhances the use of the fixture when setting SSS 36 and BSS 38 as a measuring device is no longer required.

FIG. 4 shows the fourth and preferred embodiment that consist of adding alignment pins 28 within slots 21. Two pins are inserted, for each support slot, into the bottom and side support member's 10c and 12c. The pin diameter is slightly smaller than the width of the slots to prevent binding when moving the supports 16c and 18c. Pins 28 ensure that side and bottom supports 16c and 18c stay parallel with support members 10c and 12c when setting dimensions SSS 36 and BSS 38. As a result, graduations 24 and index marks 26 are needed just on one end of each support 16c and 18c and support member's 10c and 12c.

FIG. 5 shows the fifth embodiment that consists of removing the side support 16 FIG. 1 and adding screw adjustment saddle or block 17 FIG. 5 with an adjustment screw/stop 19 and locking setscrew 23. The saddle or block 17 is attached to side fixture member 12 with screws 20. Although this configuration simplifies the construction of the fixture, a measuring device is needed to set dimension 36. In addition, the assumption is that bottom support 18c aligns the drawer box front member 30 FIG. 7 square to the drawer front/face 40 FIG. 6 thus requiring only a stop to establish dimension 36 FIG. 5.

### Operation—FIGS. 6,7,8,9

The first step in the use of this fixture is to determine side support setting (SSS) 36 and bottom support setting (BSS) 38, FIG. 6. Following is a formula to calculate these dimensions:

Side support setting (SSS) 36 calculations:
For full inset installation of the drawer front/face, measure drawer slide set back dimension 32, FIG. 7 and subtract desired side clearance of drawer front/face when installed. Set side support 16c, FIG. 6 to this dimension.
For overlay installation of the drawer front/face, measure drawer slide set back dimension 32, FIG. 7 and add the desired overlay of drawer front/face when installed. Set side support 16c, FIG. 6 to this dimension.

Bottom support setting (BSS) 38 calculation:
For full inset installation of the drawer front/face, measure drawer bottom clearance 34, FIG. 7 and subtract desired bottom clearance of drawer front/face when installed. Set bottom support 18c, FIG. 6 to this dimension.
For overlay installation of the drawer front/face, measure drawer bottom clearance 34, FIG. 7 and add the desired overlay of drawer front/face when installed. Set bottom support 18c, FIG. 6 to this dimension.

Drill holes 31, FIG. 7 in drawer box front member 30. Ideally, holes 31 should be slightly larger than the screws that will be used to hold the drawer front/face 40 FIG. 6 in place. This can allow for fine adjustment of the drawer front/face 40 when installed in the cabinet box.

Place drawer front/face 40 on fixture base 14, finished side down. The drawer front/face should be tight against bottom and side support member's 10c and 12c, and under side and bottom supports 16c and 18c.

Place drawer box front member 30, FIG. 8 on drawer front/face 40 with drawer box L/H side 44 against side support 16c and the bottom of the drawer box front member 30 against bottom support 18c, FIG. 9. Note that, drawer box bottom 46 should be towards bottom of fixture. Install screws through holes 31 into drawer front/face 40. Remove drawer assembly from fixture and install into cabinet. Adjust drawer front/face as needed. Typically only horizontal adjustment may be needed, if at all.

### FIGS. 1-3 and 5

### Additional Embodiments

Additional embodiments are shown in FIGS. 1, 2, 3 and 5.

FIG. 1 shows the simplest way to construct this fixture by attaching side support 16 and bottom support 18 with screws. It is a practicable use of this fixture if dimensions 36 and 38 never change. However, in practice this is unlikely.

FIG. 2 shows the side support 16a and bottom support 18a modified with slots 21 to allow easier adjustments of dimensions 36 and 38. The fixture is furthered modified with threads in fixture member's 10a and 12a to accept screw knobs 22. Dimensions 36 and 38 can be set with a measuring tape or rule and the side and bottom supports 16a and 18a secured in place with screw knobs 22. This modification allows ease in changing dimensions 36 and 38.

FIG. 3 shows the fixture with the addition of graduations in English and/or metric 24 on the side and bottom supports 16b and 18b. An index mark is added to fixture member 10b and 12b and calibrated to the graduations.

FIG. 5 shows the fixture modified with a screw adjustment saddle or block 17 in place side support 16c FIG. 4 assembly. The adjustment screw/stop 19 FIG. 5 simplifies the construction of the fixture, however, a measuring device is required to set dimension 36.

### CONCLUSION, RAMIFICATIONS, AND SCOPE

Thus, there has been described a simple device and method for attaching a drawer front/face to a drawer box. In fact, this device and method will reduce the time to install a drawer front/face to a drawer box to a fraction of the time required for prior art methods. Additionally, the present device reduces the number of errors associated with prior art systems.

While this device has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

We claim:

1. Portable device/fixture used in the manufacture or modifications of cabinets, to provide a means of accurately attaching a drawer front/face to a drawer box comprising of:
a. one side member joined perpendicular to one bottom member;
b. said members attached to a fixture base;
c. two supports attached to said members, so that said supports are parallel to said members at predetermined settings;
d. said drawer front/face placed on said fixture base against said members, and under said supports;
whereby, said drawer box is placed on said drawer front/face against said supports; and
secured to said drawer front/face in proper alignment to each other.

2. The device of claim 1 wherein said members are threaded to accept screw knobs;

3. The said members of claim 2 wherein index marks are added;

4. The device of claim 1 wherein said supports are slotted to accept said screw knobs;

5. The said supports of claim 4 wherein graduations, in English and/or metric, are added to said supports, and are calibrated to said index marks;

6. The said supports of claim 4 wherein pins are added in the slots;
whereby, providing a means of adjustment, setting and maintaining said supports parallel to said members.

7. Portable device/fixture used in the manufacture or modifications of cabinets, to provide a means of accurately attaching a drawer front/face to a drawer box comprising of;
a. one side member joined perpendicular to one bottom member;
b. said members attached to a fixture base;
c. one support attached to said bottom member, so that said support is parallel to said bottom member at predetermined setting;
d. one screw adjustment saddle or block is attached to said side member with an adjustment screw/stop;
e. said adjustment screw/stop is set to a determined setting;
f. said drawer front/face is placed on said fixture base against said members, and under said bottom support and said adjustment screw/stop;
whereby, said drawer box is placed on said drawer front/face against said bottom support,
and said adjustment screw/stop and secured to said drawer front/face in proper alignment to each other.

8. The device of claim 7 wherein said bottom member is threaded to accept screw knobs;

9. The said bottom member of claim 7 wherein index marks are added;

10. The device of claim 7 wherein said bottom support is slotted to accept said screw knobs;

11. The said bottom support of claim 10 wherein graduations, in English and/or metric, are added to said bottom support, and are calibrated to said index marks;

12. The said support of claim 10 wherein pins are added in the slots;
whereby, providing a means of adjustment, setting and maintaining said support parallel to said bottom fixture member.
